(19) United States
(12) Patent Application Publication
(10) Pub. No.: US 2026/0046810 A1
(43) Pub. Date: Feb. 12, 2026

(54) CARRIER PHASE POSITIONING TECHNIQUE

(71) Applicant: Sony Group Corporation, Tokyo (JP)

(72) Inventors: Basuki PRIYANTO, Lund (SE); Yujie ZHANG, Lund (SE)

(21) Appl. No.: 19/100,059

(22) PCT Filed: Aug. 2, 2023
(86) PCT No.: PCT/EP2023/071481

§ 371 Date: Jan. 30, 2025

(30) Foreign Application Priority Data
Aug. 11, 2022 (SE) 2250958-2

(51) Int. Cl. H04W 64/00; H04L 5/00; H04W 24/10

(52) U.S. Cl. CPC H04W 64/00; H04L 5/0051; H04W 24/10

(57) ABSTRACT

Examples disclose a method of operating a communication node, in particular a UE, or an access node (AN), comprising: receiving, on a wireless channel, a location determination signal (LDS), in particular a positioning reference signal (PRS), on at least a first subcarrier and a second subcarrier; and providing, to a location server node (LN) a message indicative of a reception phase of the LDS on the first subcarrier. Further examples disclose a method of operating a location server node comprising obtaining, from a communication node a message indicative of a reception phase of a location determination signal on a first subcarrier. Some examples disclose a location server node comprising control circuitry configured for performing the aforementioned method. Further examples disclose a communication node comprising control circuitry configured for performing the aforementioned method.

### TECHNICAL FIELD

Various examples generally relate to determining a position of a wireless device.

### BACKGROUND

Positioning functions and services as specified by the 3rd Generation Partnership Project (3GPP), in particular in 3GPP TS 38.305 v17.1.0, have been designed to support positioning services in many commercial and public safety use cases involving wireless devices (also called user equipment, UE) operating in a communication network.

### SUMMARY

Accordingly, there may be a need for techniques allowing for an even higher positioning accuracy and/or integrity.

Said need has been addressed with the subject-matter of the independent claims. Advantageous embodiments are described in the dependent claims.

Examples disclose a method of operating a communication node, in particular a UE, or an access node (AN), comprising: receiving, on a wireless channel, a location determination signal (LDS), in particular a positioning reference signal (PRS), on at least a first subcarrier and a second subcarrier; and providing, to a location server node (LN) a message indicative of a reception phase of the LDS on the first subcarrier.

Further examples disclose a method of operating a location server node comprising obtaining, from a communication node a message indicative of a reception phase of a location determination signal on a first subcarrier.

Some examples disclose a location server node comprising control circuitry configured for performing the aforementioned method.

Further examples disclose a communication node comprising control circuitry configured for performing the aforementioned method.

### BRIEF DESCRIPTION OF THE DRAWINGS

FIG. 1 schematically illustrates a communication network.

FIG. 2 schematically illustrates a method to determine a distance.

FIG. 3 schematically illustrates a carrier and subcarriers.

FIG. 4 schematically illustrates integer ambiguity and phase for different frequencies.

FIG. 5 schematically illustrates signaling.

FIG. 6 schematically illustrates signaling.

FIG. 7 schematically illustrates a method of operating a communication node.

### DETAILED DESCRIPTION

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

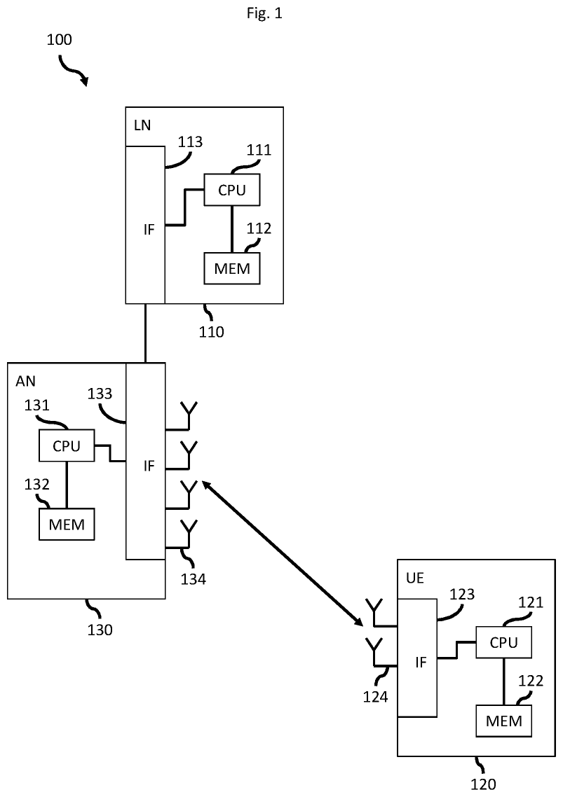

FIG. 1 illustrates a communication environment 100 comprising a wireless device 120, an access node (AN) 130 and a location server node (LN) 110. The wireless device 120 includes control circuitry that is implemented by a processor 121, a non-volatile memory 122 and an interface 123 that can access and control one or more antennas 124. Likewise, the AN 130 comprises control circuitry that is implemented by a processor 131, a non-volatile memory 132 and an interface 133 that can access and control one or more antennas 134. The location server node (LN 110) may correspond to an LMF as specified in 3GPP TS 38.305 V17.1.0. The LN 110 may also comprise control circuitry implemented by a processor 111, a non-volatile memory 112 and an interface 113 that provides a wired or wireless link to the AN 130.

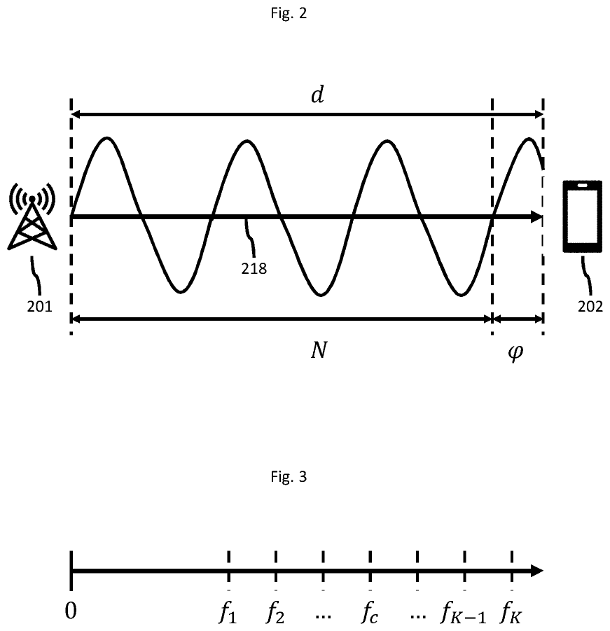

FIG. 2 illustrates a possibility to determine the distance d between an AN and UE in terms of a wavelength c/f of a carrier frequency f of a signal communicated between the AN and the UE travelling at the speed of light c. In particular, the distance d may be expressed in terms of integer multiples N of the wavelength c/f and a reception phase φ of the signal. The calculated N at the receiver may also be called integer ambiguity.

In particular, the distance d may be determined as follows:

$$d = \frac{c}{f} ( N + \frac{φ}{2 π} ) .$$

The transmitted signal may be used to determine a position and/or location of the UE and may be called location determination signal (LDS). However, due to fundamental properties of trigonometric functions (i.e., sin (φ+2π)=sin (φ)), the integer number of cycles N is not derivable from the received phase φ alone.

At the receiver, the received signal at radio frequency (RF) is down converted to baseband frequency. The reception phase measurement may be carried out in baseband after the analog to digital converter (ADC). Hence, it can be processed digitally. In examples, it may be performed using a regular RF receiver of a communication node, in particular of a UE or an AN.

In some examples, the LDS may correspond to a positioning reference signal (PRS). The LDS signal may be an orthogonal frequency-division multiplexed (OFDM) signal. In the legacy 3GPP New Radio (NR) system, it can be Downlink (DL) PRS or Uplink (UL) Sounding Reference Signal (SRS).

The passband

$${x}_{k}^{TX} ( t )$$

for k-th subcarrier frequency of an LDS OFDM signal may be modeled by:

$${x}_{k}^{TX} ( t ) = {A}_{k} {e}^{j {φ}_{k} ( t )} = {A}_{k} {e}^{j {φ}_{0}^{TX} + j 2 π ( {f}_{c} + {f}_{k} ) t} ,$$

wherein Aₖ is the complex amplitude of the modulated signal, φₖ(t) is the signal phase. The signal phase φₖ(t) is a linear function of the frequency (f_{c}+fₖ), wherein f_{c} is the carrier frequency and fₖ is the subcarrier frequency, and

$${φ}_{0}^{TX}$$

is the initial phase from the communication node transmitting the LDS signal.

$${φ}_{0}^{TX}$$

may be assumed to be constant.

The received signal

$${x}_{k}^{RX} ( t )$$

may be expressed as a convolution of the LDS

$${x}_{k}^{TX} ( t )$$

with the channel impulse response hₖe^{-j2π(f}^{_{c}}^{+f}^{ₖ}^{)τ} as follows:

$${x}_{k}^{RX} ( t ) = {A}_{k} {e}^{j {φ}_{0}^{TX} + j 2 π ( {f}_{c} + {f}_{k} ) t} * {h}_{k} {e}^{- j 2 π ( {f}_{c} + {f}_{k} ) τ} ,$$

wherein hₖ is the complex channel coefficient at time delay τ.

To down convert the passband signal

$${x}_{k}^{RX} ( t )$$

to baseband signal yₖ, the receiver of the LDS may perform a multiplication between the passband signal and the corresponding complex conjugate mixer signal xₘᵢₓ(t):

$${y}_{k} = {x}_{k}^{RX} ( t ) * {x}_{mix}^{*} ( t ) = {h}_{k} {e}^{- j 2 π ( {f}_{c} + {f}_{k} ) τ + j ( {φ}_{0}^{TX} - {φ}_{0}^{RX} )} ,$$

wherein

$${x}_{mix} ( t ) = \frac{1}{{A}_{k}^{*}} {e}^{j 2 π ( {f}_{c} + {f}_{k} ) t + j {φ}_{0}^{RX}} and {φ}_{0}^{RX}$$

is the phase error from the receiver side.

After that, an estimated phase in terms of a fraction of 2π for each subcarrier \tilde{φ}ₖ may be directly derived from the baseband yₖ as follows:

$${\tilde{φ}}_{k} = arg ( {y}_{k} ) ,$$

wherein arg(.) is a function to return the phase angle of a complex value.

However, the aforementioned method only enables derivation of the reception phase. The value of N remains unknown.

The value of N has to be derived by other means. In examples, the value of N may be obtained by deriving phases for virtual frequencies.

The receiver of the LDS may derive an estimate reception phase Pk for different subcarriers k.

FIG. 3 illustrates the carrier and subcarriers with their respective frequencies fₖ, wherein k∈1, . . . , c, . . . , K. The carrier f_{c} is located at the center of the frequencies fₖ.

Reception phases (φ₁, φ₂, . . . , φ_{c}, . . . , φ_{K}) may be estimated for each frequency fₖ including the carrier frequency f_{c}. For each frequency fₖ the reception phases fulfil the equation:

$${φ}_{k} = 2 π ( {f}_{k} \frac{d}{c} - {N}_{k} ) , k = 1 , 2 , ... , c ... , K ,$$

where Nₖ refers to the respective integer ambiguity.

The difference φₖ−φ₁ for every k∈2, . . . , c, . . . , K then reads as follows

$${φ}_{2} - {φ}_{1} = 2 π ( 1 * {f}_{SCS} * \frac{d}{c} - {N}_{2 , 1} ) ,$$

$${φ}_{3} - {φ}_{1} = 2 π ( 2 * {f}_{SCS} * \frac{d}{c} - {N}_{3 , 1} ) ,$$

$$…$$

$${φ}_{K} - {φ}_{1} = 2 π ( ( K - 1 ) * {f}_{SCS} * \frac{d}{c} - {N}_{K , 1} ) ,$$

wherein N_{k,1} denotes the difference between the first and the k-th integer ambiguity and f_{SCS} is the subcarrier spacing. The terms (k−1)*f_{SCS} may be considered as virtual frequencies with increasing frequency values.

An initial (coarse) distance estimate \tilde{d}¹ may be calculated using the lowest virtual frequency 1*f_{SCS}. Typically, 1*f_{SCS} is a comparably low frequency corresponding to a long wavelength

$$\frac{c}{{f}_{SCS}} .$$

The assumption the said wavelength is longer than the distance between the communication nodes, i.e.

$$\frac{c}{{f}_{SCS}} > d$$

leads to N_{2,1}=0.

Using N_{2,1}=0 in

$${φ}_{2} - {φ}_{1} = 2 π ( 1 * {f}_{SCS} * \frac{d}{c} - {N}_{2 , 1} )$$

may allow for obtaining a first (coarse) distance estimate \tilde{d}¹:

$${φ}_{2} - {φ}_{1} = 2 π ( 1 * {f}_{SCS} * \frac{{\tilde{d}}^{1}}{c} ) ,$$

$${\tilde{d}}^{1} = c * \frac{{φ}_{2} - {φ}_{1}}{2 π * {f}_{SCS}} .$$

Thereafter, the first (coarse) distance \tilde{d}¹ may serve to provide an estimate for N_{3,1} corresponding to the higher frequency 2*f_{SCS} as follows:

$${φ}_{3} - {φ}_{1} = 2 π ( 2 * {f}_{SCS} * \frac{{\tilde{d}}^{1}}{c} - {N}_{3 , 1} ) ,$$

$${\tilde{N}}_{3 , 1} = [ 2 * {f}_{SCS} * \frac{{\tilde{d}}^{1}}{c} - \frac{{φ}_{3} - {φ}_{1}}{2 π} ] ,$$

wherein [*] indicates a rounding operation. The rounding operation may output the closest integer.

Ñ_{3,1} may then be used to determine a new second distance estimate \tilde{d}² according to

$${φ}_{3} - {φ}_{1} = 2 π ( 2 * {f}_{SCS} * \frac{{\tilde{d}}^{2}}{c} - {\tilde{N}}_{3 , 1} ) ,$$

$${\tilde{d}}^{2} = \frac{c}{2 * {f}_{SCS}} * ( \frac{{φ}_{3} - {φ}_{1}}{2 π} + {\tilde{N}}_{3 , 1} ) .$$

\tilde{d}² may then again be used to determine an estimate for Ñ_{4,1}, Ñ_{4,1} to determine an estimate for \tilde{d}³, etc. until finally an estimate for N_{K,1}=N_{K} is obtained and the problem actually solved.

Hence, receiving an LDS on a first subcarrier and a second subcarrier as well as determining a reception phases of the LDS may allow for improving the positioning accuracy. In particular, it may enable solving the integer ambiguity issue.

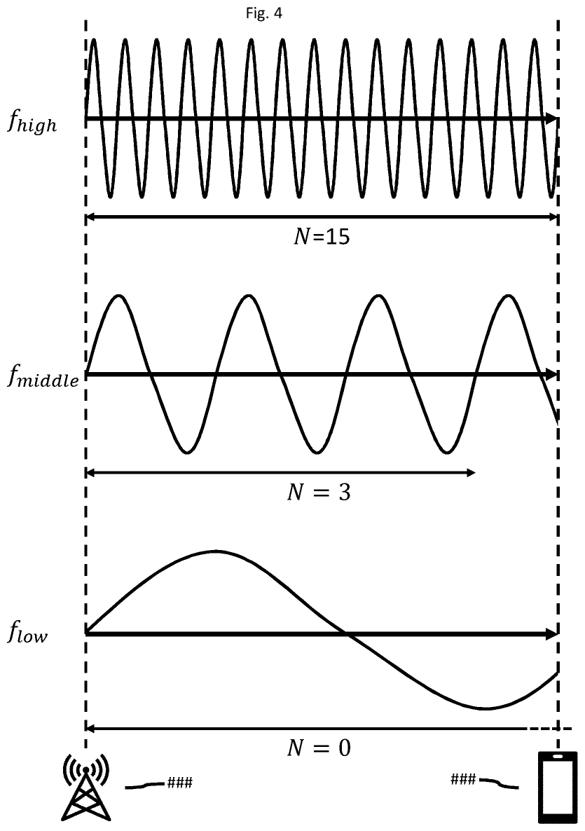

The method utilizes the different properties of a low frequency (f_{low}), a middle frequency (f_{middle}) and a high frequency (f_{high}) as illustrated with respect to FIG. 4. Low frequencies correspond to long wavelengths, for which integer ambiguity is easy to resolve, but the fractional phase accuracy is poor. For example, in Frequency Range 1 (FR1) for 5G New Radio (5G NR) as specified by 3GPP, one of the SCSs is 30 kHz, which corresponds to a wavelength of roughly 10 km. A distance between a communication node transmitting the LDS and the communication node receiving the LDS will not exceed said range of 10 km. Hence, the assumption of an integer ambiguity of zero used above is justified.

On the other side, the accuracy of the distance estimation mainly relies on the received phase measurement, which may not be very accurate for low (virtual) frequencies. However, high frequency has much shorter wavelength, e.g., for a 6 GHz carrier frequency of FR1, the wavelength is approximately 0.05 m. Therefore, the corresponding distance estimate can be very accurate because the integer ambiguity can be resolved with the method as described hereinbefore.

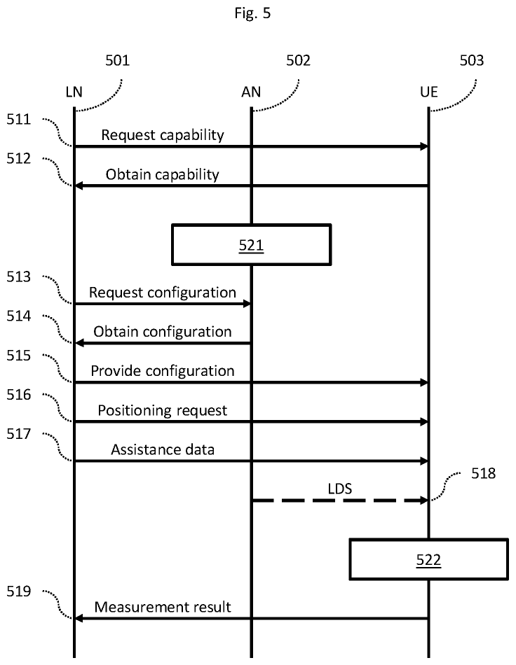

FIG. 5 illustrates signaling between a LN 501, an AN 502 and a UE 503 which may be used to determine a position of the UE 503 based on a reception phase of an LDS. In practice, there can be multiple ANs involving serving and neighbor ANs in a UE positioning procedure. Hence, the LN 501 can perform multilateration for UE positioning estimate.

Many wireless communication systems, for example 5G NR wireless communication systems, are based on multi-carrier transmissions. Orthogonal Frequency Division Multiplexing (OFDM) may be used for communicating signals between communication nodes of the wireless communication system. A wideband transmission may be divided into multiple subcarriers each having a narrow bandwidth. In 5G NR wireless communication systems the bandwidth of each subcarrier is also known as sub-carrier spacing (SCS). Reception phase measurements (or carrier phase measurements, CPM) on multiple subcarriers may enable carrier phase positioning (CPP) techniques leading to improved positioning. A single CPP together with other positioning techniques may already help to improve the positioning. Using several CPP may lead to even better results and render the positioning more robust with respect to errors due to the propagation of the LDS on the wireless channel being typically affected by multipath propagation and noise as well as hardware imperfections on the receiver and transmitter side.

The LN 501 may provide a message 511 to the UE 503 requesting the UE 503 to provide information on its capabilities. Depending on the UE design complexity and cost, various UE in 5G N R may have different capabilities. In particular, the LN 501 may request whether the UE 503 is capable of performing reception phase measurements. The LN 501 may also request whether the UE 503 is capable of deriving a propagation distance of an LDS based on a reception phase of the LDS on a first subcarrier and a reception phase of the LDS on a second subcarrier.

Deriving a propagation distance of the LDS based on a reception phase the LDS on the first subcarrier and a reception phase of the LDS on a second subcarrier may require substantial calculations. For example, solving an integer ambiguity as described hereinbefore may induce a high computational load. Thus, in some cases it may be beneficial that the UE 503 only measures reception phases on two or more subcarriers and transmits a message indicative of the respective reception phases to the LN 501, which may then perform the necessary calculations to derive the propagation distance of the LDS. In other scenarios, it may be advantageous that the UE 503 with a better UE capability performs the calculations, because transmitting a message indicative of the propagation distance of the LDS may require less wireless resources (i.e., due to smaller reporting size) than transmitting a message indicative of all the reception phase measurements.

The LN 501 may obtain, in particular from the UE 503, a message 512 indicative of the UE 512 being capable of performing reception phase measurements. The message 512 may also be indicative of a capability of the UE 503 to derive a propagation distance of the LDS based on a reception phase of the LDS on the first subcarrier and a reception phase of the LDS on the second subcarrier. The message 512 may also indicate of a capability of the UE 503 to process the number of subcarriers. It could be a set of subcarriers within a positioning frequency layer (PFL) or the set of subcarriers in more than one PFL.

At 521, the AN 502 may determine a configuration for an LDS 518 to be later transmitted from the AN 502 to the UE 503. The configuration may be indicative of subcarriers to be used for transmitting the LDS. The configuration for the LDS may correspond to a configuration of downlink positioning reference signals (DL-PRS).

The LN 501 may provide, to the AN 502, a message 513 requesting information on the configuration for the LDS 518 and obtain, in response, a message 514 indicative of the configuration for the LDS 518. The LN 501 may provide, to the UE 503, a message 515 indicative of the configuration for the LDS.

The UE 503 may obtain, from the LN 501 a message 516 triggering the UE 503 to perform a phase measurement on the first subcarrier and the second subcarrier. The message 516 may correspond to a positioning request.

In addition, the UE 503 may obtain, from the LN 501, a message 517 with assistance data related to CPP operation.

The UE 503 may receive the LDS 518 from the AN 502. At 522, the UE 503 may perform CPM, such as measure a reception phase of the LDS 518 on the first subcarrier and a reception phase of the LDS 518 on the second subcarrier. Some other UEs, particularly with better capability, may perform additional operation, such as computation of propagation distance. In some scenarios, the UE 503 may receive LDS from more than one AN. Determining propagation distances with respect to several AN may allow for determining a position of the UE 503 based on triangulation.

The LN 501 obtains, from the UE 503, a message 519 indicative of a reception phase of the LDS 518 on the first subcarrier. The message 519 may also be indicative of a reception phase of the LDS on the second subcarrier. In some examples, the message 519 may be indicative of a propagation distance of the LDS expressed in multiples of the wavelength of the first subcarrier.

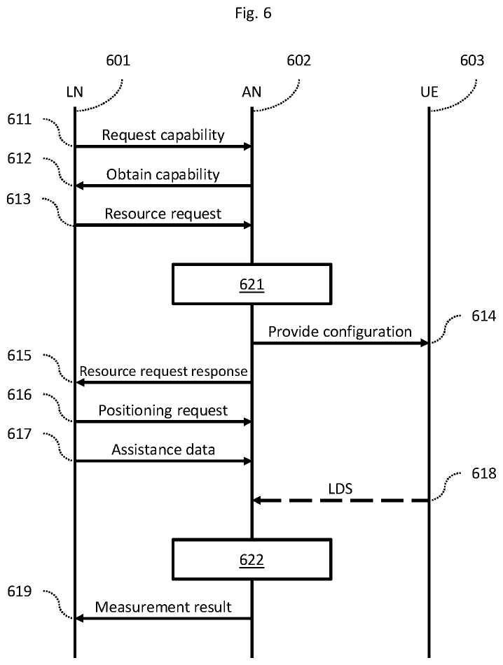

FIG. 6 illustrates signaling between a LN 601, an AN 602 and a UE 603 in another scenario.

The LN 601 may provide a message 611 to the AN 602 requesting the AN 602 to provide information on its capabilities. In particular, the LN 601 may request if the AN 602 is capable of performing reception phase measurements. The LN 601 may also request if the AN 602 is capable of deriving a propagation distance of an LDS based on a reception phase of the LDS on a first subcarrier and a reception phase of the LDS on a second subcarrier.

The AN 602 may provide, to the LN 601, a message 612 indicative of the AN 612 being capable of performing reception phase measurements. The message 612 may also be indicative of a capability of the AN 602 to derive a propagation distance of the LS based on a reception phase of the LDS on the first subcarrier and a reception phase of the LDS on the second subcarrier.

The LN 601 may provide, to the AN 602, a message 613 triggering the AN 602 to configure resources for the transmission of an LDS. In response, at 621, the AN 602 may configure the resources for the transmission of the LDS. The UE 603 may obtain, from the AN 602, a message 614 indicative of the configured resources. Likewise, the AN 602 may provide a message 615 indicative of resources for the LDS having been configured to the LN 601.

The AN 602 may obtain, from the LN 601, a message 616 requesting the AN 602 to perform reception phase measurements. The LN 601 may provide, to the AN 602, a message 617 with assistance data for performing reception phase measurements and/or for deriving a propagation distance.

The UE 603 transmits an LDS 618 to the AN 602 according to the configured resources. At 622, the AN 602 performs reception phase measurements. The AN 602 then provides, to the LN 601, a message 619 indicative of a reception phase of the LDS on the first subcarrier. As explained hereinbefore, the message 619 may also be indicative of a propagation distance of the LDS expressed in multiples of the wavelength of the first subcarrier. More than one AN may receive the LDS from the UE 601 and perform reception phase measurements independently from one another. This may allow for deriving a propagation distance of the LDS from the UE 603 to several AN 602 and therefore an estimation of the position of the UE 603 by triangulation.

In particular, it is proposed that a communication node receiving an LDS reports the result of carrier phase measurements, i.e. reception phases, based on subcarrier level.

There may be two options for providing such a carrier phase measurement reports. According to examples, the communication node receiving the LDS reports a set of reception phases (e.g., a vector of fractional phase measurement results).

Further examples may prescribe that the communication node reports a single value representing the reception phase measurements, in which this single value is obtained by further post-processing of the previously obtained reception phases. This single value may comprise an integer part and a decimal part. For example, the communication node may report a carrier phase measurement ‘76.45’, wherein 76 represents the integer ambiguity and 0.45 the reception phase in fractions of 2π. The carrier phase measurement format may vary in different positioning schemes.

For downlink time difference of arrival (DL-TDOA), a UE may report the carrier phase difference between the carrier phase from a reference AN and the carrier phase from a neighboring AN. This measurement may be considered as a counterpart of reference signal time difference (RSTD).

For Multi-cell round trip time (Multi-RTT) positioning schemes, the receiver reports the summation of the carrier phase from the Rx signal and the carrier phase from Tx signal. This measurement can be seen as a counter part of RTT measurement.

As described hereinbefore, the LN may provide assistance data to the communication node performing the reception phase measurement. For example, the LN may provide assistance data in the form of a coarse location estimate of the communication node the position of which is to be estimated. In other examples, the LN may provide a coarse ranging estimate of the communication node the position of which is to be estimated. This may facilitate to resolve the integer ambiguity. Together with a coarse location and/or range estimate, the LN may also report an uncertainty. As an example, in the case of reporting course range estimate, the LN may report it in a form of {Distance±uncertainty}.

Further, the assistance data may include an indication of a line-of-sight (LOS) between the communication nodes exchanging the LDS. The LN may have historic data indicative of wireless communications nodes being in LOS. In this case, the LN may indicate that a pair of wireless communication nodes being in LOS may exchange the LDS and perform CPM. Furthermore, the assistance data may include an indication of the preferred AN(s) to be used for CPP operation.

Some UEs may not be able to perform proper CPM due to hardware limitations, such as RF chains with large phase noise, which would lead to bad positioning estimates. Thus, the UE may provide information on its capabilities to the LN. For example, the UE may provide capability information related to the UE imperfection. For example, to initiate a reception phase measurement, LN may need to request an imperfection capability information from the UE. If the UE fails to meet the requirements for CPP, the UE decide to abort the measurement and possibly inform the LN accordingly.

The reception phase measurement may be performed with downlink (DL) and uplink (UL) transmissions. For example, the AN may transmit the LDS and the UE may perform the reception phase measurement (CPM) or the UE may transmit the LDS and the AN may perform the reception phase measurement.

The communication node may indicate which type of reception phase measurement report it supports. In some examples, the communication network (i.e., the AN and the UE) may be configured to support at least one option. Carrier phase measurements may be selectively reported by the communication node based on the signal quality. This may be helpful, if the reception phase measurement is to be performed in a wideband channel. There could be a frequency selective fading in a wideband channel. Hence, there would not be beneficial to report the carrier phase measurement result for the sub-carrier in a deep-fading.

The communication node may be configured to only perform CPM or perform CPM together with other positioning method (e.g., CPM together with DL-TDOA or CPM together with UL-TDOA or Multi-RTT).

Thus, the communication node may report carrier phase measurements only or the communication node may report carrier phase measurement and other positioning measurement (e.g., RSTD).

The communication node may be configured to perform CPM based on a given positioning reference signals. (e.g., it could be a sub-set of PRS (a portion from a given bandwidth), or a given frequency layer from a plurality of frequency layers).

The message indicative of the reception phase of the LDS on the first subcarrier may include further information. For example, the message may include a parameter indicative of the quality of the carrier phase measurement. Those parameter may include a Signal to Noise Ratio (SNR) and/or an LOS indicator. The message may also be indicative of a hardware condition of the communication node at the time when the reception phase measurement is performed. For example, if the receiver gets heated, it may affect the oscillator drift, which may increase the measurement error.

The communication node may be configured to perform or report the CPP based on the signal quality (or LOS/NLOS indication) from a given base-station or from the selected base-station (e.g., best N). Here, the measurement report can be sorted based on the signal quality (prioritization). The measurement report from a bad measurement can be omitted.

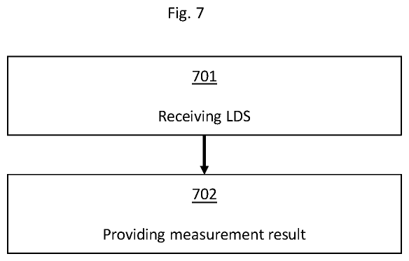

FIG. 7 briefly illustrates a method of operating a communication node. At 701, the communication node receives, on a wireless channel, a location determination signal, LDS, in particular a positioning reference signal, PRS, on at least a first subcarrier and a second subcarrier. At 702, the communication node provides, to a location server node, LN, a message indicative of a reception phase of the LDS on the first subcarrier.

Summarizing, at least the following EXAMPLES have been described above:

EXAMPLE 1. A method of operating a communication node, in particular a wireless device, UE, or an access node, AN, comprising
receiving, on a wireless channel, a location determination signal, LDS, in particular a positioning reference signal, PRS, on at least a first subcarrier and a second subcarrier; and
providing, to a location server node, LN, a message indicative of a reception phase of the LDS on the first subcarrier.

EXAMPLE 2. The method of operating a communication node of EXAMPLE 1, wherein the message indicative of the reception phase of the LDS on the first subcarrier is also indicative of a reception phase of the LDS on the second subcarrier.

EXAMPLE 3. The method of operating a communication node of EXAMPLE 1 or 2, wherein the message indicative of the reception phase of the LDS on the first subcarrier is also indicative of a propagation distance of the LDS expressed in multiples of the wavelength of the first subcarrier.

EXAMPLE 4. The method of operating the communication node of any one of EXAMPLEs 1 to 3, further comprising
providing, to the LN, a message indicative of a capability of the communication node to perform a phase measurement on the first subcarrier and the second subcarrier.

EXAMPLE 5. The method of operating the communication node of any one of EXAMPLEs 1 to 4, further comprising
providing, to the LN, a message indicative of a capability of the communication node to derive a propagation distance of the LDS based on a reception phase of the LDS on the first subcarrier and a reception phase of the LDS on the second subcarrier.

EXAMPLE 6. The method of operating the communication node of any one of EXAMPLEs 1 to 5, further comprising
obtaining, from the LN, a message triggering the communication node to perform a phase measurement on the first subcarrier and the second subcarrier.

EXAMPLE 7. The method of operating the communication node of any one of EXAMPLEs 1 to 6, further comprising
obtaining, from the LN, assistance data.

EXAMPLE 8. The method of operating the communication node of any one of EXAMPLEs 1 to 7,
wherein the message indicative of the reception phase of the LDS on the first subcarrier is indicative of a signal quality of the LDS.

EXAMPLE 9. The method of operating the communication node of any one of EXAMPLEs 1 to 8,
wherein the providing the message indicative of a reception phase of the PRS on the first subcarrier is selectively executed based on a determined signal quality of the LDS.

EXAMPLE 10. The method of operating the communication node of any one of EXAMPLEs 1 to 9,
wherein the message indicative of the reception phase of the LDS on the first subcarrier is indicative of a line-of-sight, LOS, reception of the LDS.

EXAMPLE 11. The method of operating the communication node of any one of EXAMPLEs 1 to 10, further comprising
obtaining a message indicative of a position estimate of the communication node.

EXAMPLE 12. The method of operating the communication node of any one of EXAMPLEs 1 5 to 11, further comprising
obtaining a message indicative of a position estimate of a transmitter of the LDS.

EXAMPLE 13. A communication node comprising control circuitry, wherein the control circuitry is configured for performing a method according to any one of EXAMPLEs 1 to 12.

EXAMPLE 14. A method of operating a location server node, LN, comprising
obtaining, from a communication node a message indicative of a reception phase of a location determination signal on a first subcarrier.

EXAMPLE 15. A location server node, LN, comprising control circuitry, wherein the control circuitry is configured for performing the method according to EXAMPLE 14.

1. A method of operating a communication node, in particular a wireless device (UE) or an access node (AN) comprising
receiving, on a wireless channel, a location determination signal (LOS) in particular a positioning reference signal (PRS) on at least a first subcarrier and a second subcarrier; and
providing, to a location server node (LN) a message indicative of a reception phase of the LOS on the first subcarrier.

2. The method of operating a communication node of claim 1,
wherein the message indicative of the reception phase of the LOS on the first subcarrier is also indicative of a reception phase of the LOS on the second subcarrier.

3. The method of operating a communication node of claim 1,
wherein the message indicative of the reception phase of the LOS on the first subcarrier is also indicative of a propagation distance of the LOS expressed in multiples of the wavelength of the first subcarrier.

4. The method of operating the communication node of claim 1, further comprising
providing, to the LN, a message indicative of a capability of the communication node to perform a phase measurement on the first subcarrier and the second subcarrier.

5. The method of operating the communication node of claim 1, further comprising
providing, to the LN, a message indicative of a capability of the communication node to derive a propagation distance of the LOS based on a reception phase of the LOS on the first subcarrier and a reception phase of the LOS on the second subcarrier.

6. The method of operating the communication node of claim 1, further comprising
obtaining, from the LN, a message triggering the communication node to perform a phase measurement on the first subcarrier and the second subcarrier.

7. The method of operating the communication node of claim 1, further comprising
obtaining, from the LN, assistance data.

8. The method of operating the communication node of claim 1,
wherein the message indicative of the reception phase of the LOS on the first subcarrier is indicative of a signal quality of the LOS.

9. The method of operating the communication node of claim 1,
wherein the providing the message indicative of a reception phase of the PRS on the first subcarrier is selectively executed based on a determined signal quality of the LOS.

10. The method of operating the communication node of claim 1,
wherein the message indicative of the reception phase of the LOS on the first subcarrier is indicative of a line-of-sight, LOS, reception of the LOS.

11. The method of operating the communication node of claim 1, further comprising
obtaining a message indicative of a position estimate of the communication node.

12. The method of operating the communication node of claim 1, further comprising
obtaining a message indicative of a position estimate of a transmitter of the LOS.

13. A communication node comprising control circuitry, wherein the control circuitry is configured for performing the method according to claim 1.

14. A method of operating a location server node (LN) comprising
obtaining, from a communication node a message indicative of a reception phase of a location determination signal on a first subcarrier.

15. A location server node (LN) comprising control circuitry, wherein the control circuitry is configured for performing the method according to claim 14.
